(19) United States
(12) Patent Application Publication
(10) Pub. No.: US 2008/0077393 A1
(43) Pub. Date: Mar. 27, 2008

(54) VIRTUAL KEYBOARD ADAPTATION FOR MULTILINGUAL INPUT

(76) Inventors: Yuqing Gao, Mount Kisco, NY (US); Liang Gu, Yorktown Heights, NY (US); Timothy K. Mathes, Ossining, NY (US); Lazkin S. Tahir, Mount Kisco, NY (US); Wei Zhang, Ossining, NY (US)

Correspondence Address: RYAN, MASON & LEWIS, LLP, 90 FOREST AVENUE, LOCUST VALLEY, NY, 11560, US

(21) Appl. No.: 11/680,870

(22) Filed: Mar. 1, 2007

Related U.S. Application Data
(60) Provisional application No. 60/841,814, filed on Sep. 1, 2006.

(51) Int. Cl. G06F 17/20

(52) U.S. Cl. 704/8

(57) ABSTRACT

Techniques for adapting a virtual keyboard for multilingual input are disclosed. By way of example, a method of adapting a virtual keyboard for multilingual input includes the steps of detecting an input language and displaying a virtual keyboard corresponding to the input language upon detection of the input language. The identifying step may include automatic identification of an input language, such as by one or more language recognition modules, or it may include manual selection of an input language and activation of at least one language recognition module operative to recognize at least the input language upon selection of the input language.

### CROSS-REFERENCE TO RELATED APPLICATIONS

The present application claims the benefit of U.S. Provisional Application No. 60/841,814, filed Sep. 1, 2006, incorporated by reference herein.

The present application is related to U.S. patent application identified by Attorney Docket No. YOR920060634US2 (entitled “Enhanced Linguistic Transformation”), filed concurrently herewith and incorporated by reference herein.

The present invention was made with Government support under Contract No. NBCH2030001 awarded by the Defense Advanced Research Projects Agency (DARPA). The Government has certain rights in this invention.

### FIELD OF THE INVENTION

This invention relates in general to multilingual input and, more particularly, to an apparatus and method for adapting a virtual keyboard for multilingual input.

### BACKGROUND OF THE INVENTION

Computers are increasingly used to perform various linguistic transformations, such as translation, transcription, transliteration, speech recognition, and speech synthesis. However, various algorithmic limitations often prevent exact transformations from being generated in all situations. Errors in linguistic transformations are simply inevitable and cause severe degradation in accuracy and performance.

One solution is to let users edit or modify the output and hence remove errors. Keyboards are often not available on a handheld device such as a personal data assistant or mobile telephone. Furthermore, physical keyboards are often not easily re-labeled to correspond with a new keyboard mapping which may be required to support multiple languages with, for example, different alphabets.

Hence, it is common to use virtual keyboards (also known as soft keyboards). These are software-implemented representations of keyboards which are displayed on a screen and from which users may then select, for example, characters. However, current multilingual input systems require the use of a hotkey to select which language should be displayed on the virtual keyboard. This hotkey-based language switching is very inconvenient and annoying to the users. For example, in speech-to-speech translation, user dialogues are frequently switched between a source language and the target language. It is thus cumbersome to have to manually change the keyboard layout every time the input language changes. Furthermore, such soft keyboards may visually overlap with a graphical user interface of a linguistic transformation program and may block some useful information, especially with the small screen size typical of handheld devices.

Thus, there is a need for improved techniques for adapting a virtual keyboard for multilingual input which permit display of an appropriate virtual keyboard upon detection of an input language.

### SUMMARY OF THE INVENTION

Principles of the invention provide improved techniques for adapting a virtual keyboard for multilingual input.

By way of example, in one aspect of the present invention, a method of adapting a virtual keyboard for multilingual input includes the steps of identifying an input language and displaying a virtual keyboard corresponding to the input language upon identification of the input language. The identifying step may include automatic identification of an input language, such as by one or more language identification modules, or it may include manual selection of an input language and activation of at least one linguistic transformation module corresponding to the input language upon selection of the input language.

In another aspect of the present invention, a method of adapting a virtual keyboard for multilingual input includes the steps of identifying an input language, obtaining an input, determining an end of the input, and displaying a virtual keyboard corresponding to the input language upon the end of the input for use in an edit of the input. The displaying step may also include the steps of detecting an end of the edit and removing the virtual keyboard upon the end of the edit.

Advantageously, principles of the invention provide improved techniques for adapting a virtual keyboard for multilingual input which permit updating of a virtual keyboard so as to minimize user inconvenience and maximize the utilization of screen space.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a flow diagram illustrating an exemplary automatic language identification method suitable for use with inventive techniques.

FIG. 2 is a flow diagram illustrating an exemplary speech-to-speech translation method incorporating inventive techniques.

FIG. 3 is an exemplary display depicting an illustrative embodiment of the invention configured for input of English speech.

FIG. 4 is an exemplary display depicting an illustrative embodiment of the invention configured for editing of English text.

FIG. 5 is an exemplary display depicting an illustrative embodiment of the invention configured for input of Arabic speech.

FIG. 6 is an exemplary display depicting an illustrative embodiment of the invention configured for editing of Arabic text.

FIG. 7 is a block diagram depicting an exemplary processing system in which techniques of the invention may be implemented.

### DETAILED DESCRIPTION OF PREFERRED EMBODIMENTS

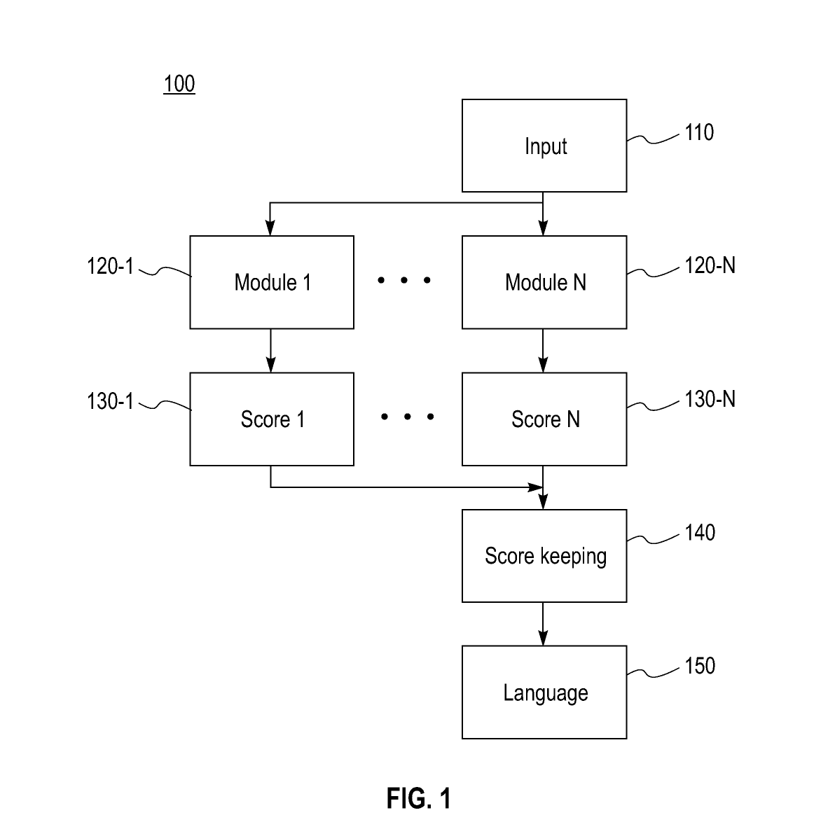

In describing the preferred embodiments, reference will be made to automatic language identification. FIG. 1 is a flow diagram illustrating an exemplary automatic language identification method suitable for use with invention techniques. Input 110, which may be speech, text, or any other linguistic data, is passed through one or more language identification (LID) modules (120-1 . . . 120-N). Each of these modules may either identify whether the input is in at least one language or determine a probability that the input is in at least one language. These LID modules may also be capable of performing further analysis such as, for example, decoding words within a language (e.g., automatic speech recognition). Each LID module may output a score (130-1 . . . 130-N), which may be binary in nature, thus indicating either that the LID module has identified a language or that it has not. The score may also be, for example, a percentage representing a probability calculated by a LID module that the input is in a given language. These LID modules may use any of the algorithms known to one skilled in the art, such as, for example, acoustic, phonetic and/or discriminative approaches.

These scores are collected by a scorekeeping module 140, which will analyze the scores 130 generated by the LID modules 120 to identify an input language. This may include determining whether any of the LID modules 120 has output a score 130 equivalent to a binary “true,” indicating that a language has been identified. It may also include determining which LID module has output the highest score, i.e., has determined the highest probability that the input is in a language which it is configured to identify. The scorekeeping module may be configured to only consider a language to have been identified if the language if the highest score exceeds some threshold, e.g., 90%, and/or if the highest score exceeds at least one other score by a certain level, e.g., is 10% higher than the next-highest score. These measures will prevent rapid oscillation of the detected language at the beginning of an input due to incomplete data. In step 150, the detected language is output. As discussed in further detail below, a virtual keyboard corresponding to the input language will be displayed responsive to this detection of an input language.

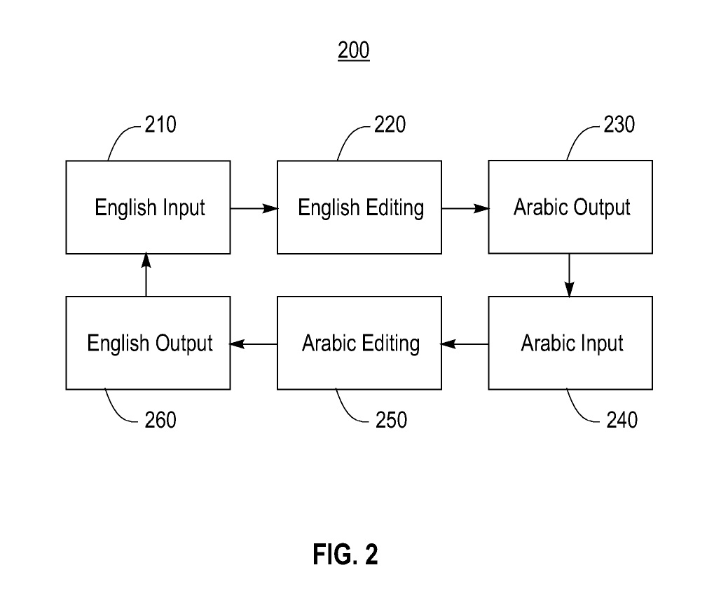

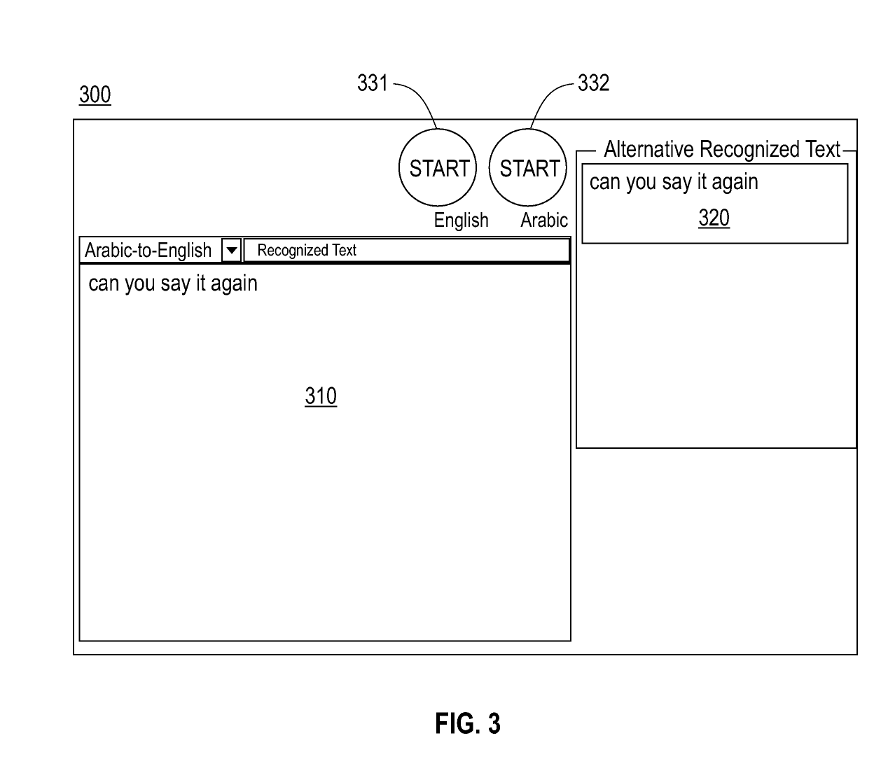

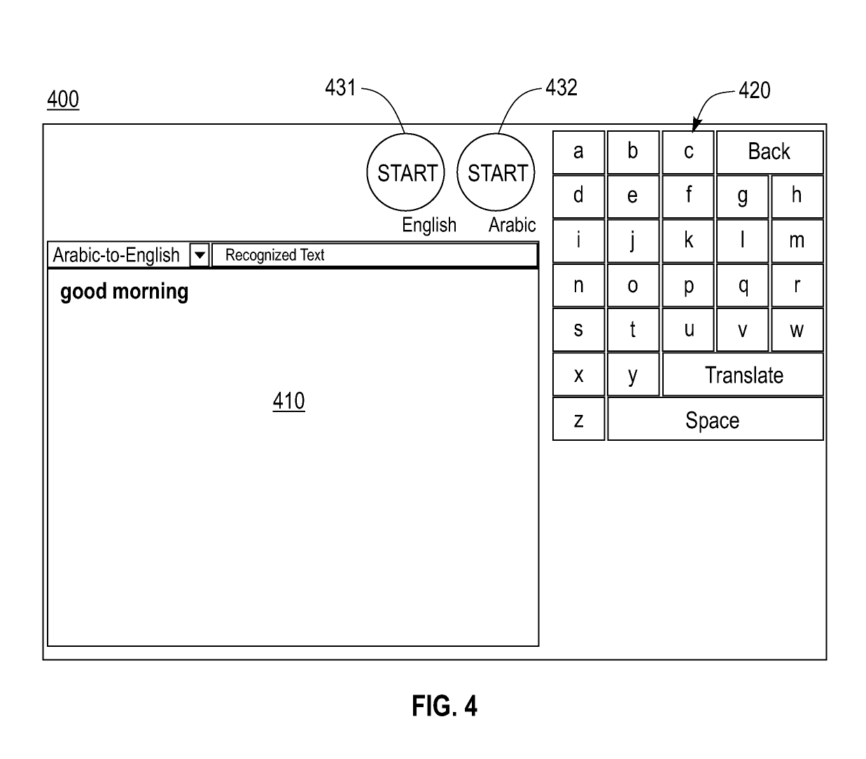

FIG. 2 is a flow diagram illustrating an exemplary speech-to-speech translation method incorporating inventive techniques. For example, method 200 may be used in conjunction with an exemplary system for speech-to-speech translation between English and Arabic. The process begins in step 210. Upon identifying English speech (e.g., via automatic language identification, such as that described with reference to FIG. 1), the system performs automatic speech recognition on the English speech and shows display 300 of FIG. 3. In step 220, the system responds to an end of the spoken input by showing display 400 of FIG. 4, wherein it presents the results of the speech recognition of step 210 as English text and permits the user to edit this text prior to translation. In step 230, responsive to the end of an edit, the text is translated into Arabic and the results output as spoken Arabic.

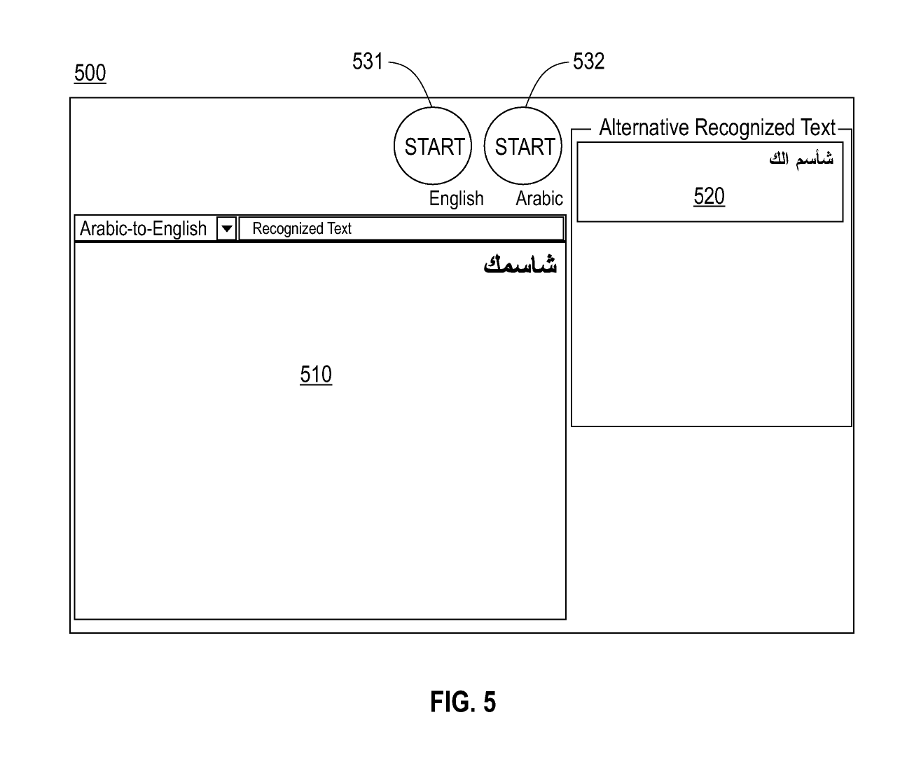

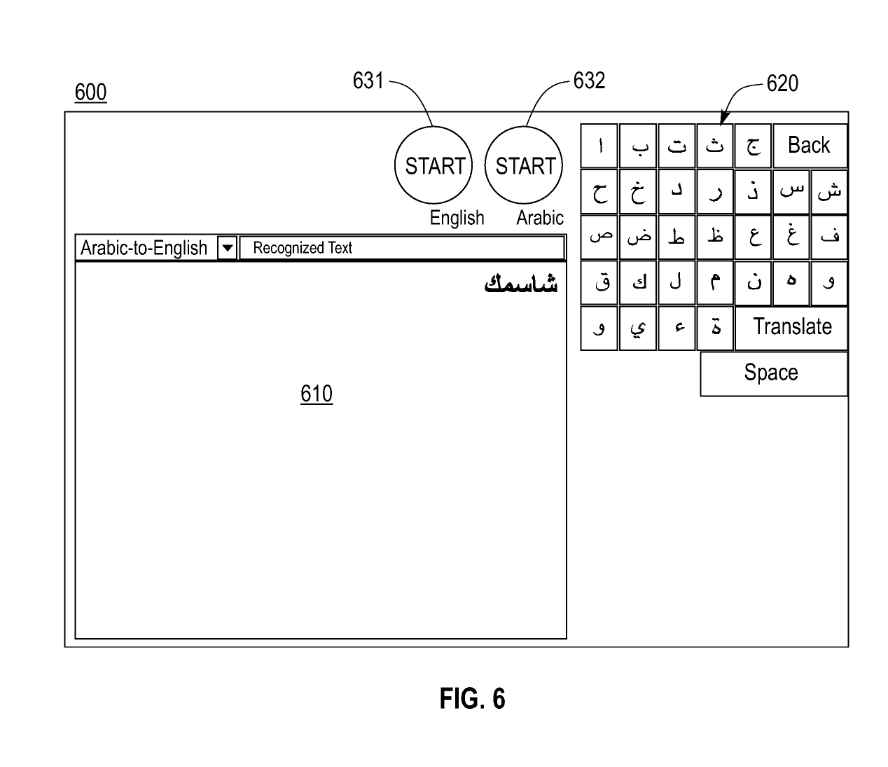

In step 240, the system identifies Arabic speech (e.g., via automatic language identification, such as that described with reference to FIG. 1) and, in response, performs automatic speech recognition on the spoken Arabic input and shows display 500 of FIG. 5. In step 250, the system responds to an end of the spoken input by showing display 600 of FIG. 6, wherein it presents the results of the speech recognition of step 240 as Arabic text and permits the user to edit this text prior to translation. In step 260, the text is translated into English and the results output as spoken English. The method may repeat by returning to step 210. This repetition may continue until the termination of a conversation, for example.

This exemplary method for speech-to-speech translation represents only an illustrative example of a method with which the techniques of the present invention may be used. For example, a text-to-text translation system may alternate directly between the layouts shown in FIGS. 4 and 6. In other words, the system may display a virtual keyboard during both input and editing. However, the keyboard is displayed in a different language depending on the language then being input. In such an embodiment, changing the layout of the keyboard may be performed responsive to either the system automatically detecting a change in the input language or by the user indicating a change in the input language. Likewise, the present invention may also be used in conjunction with methods and systems for performing other linguistic transformations, such as transliteration, transcription, or textual translation. Other such variations will be apparent to one skilled in the art.

FIG. 3 is an exemplary display depicting an illustrative embodiment of the invention responsive to spoken English input. In display 300, the section of screen labeled 310 displays the results of a speech recognition operation upon the spoken English input. There is no cursor visible in 310, thus indicating the user is not editing the text at this time. Here, the section of screen labeled 320 displays alternative recognized text. It should be noted that is merely an exemplary display and that other arrangements of components, e.g., modifications to their sizes or positions, will be apparent to one skilled in the art. For example, display 300 does not include a virtual keyboard; however, in an embodiment where the input includes text rather than speech, a virtual keyboard may be present and used during the input stage. The system may determine that the user has finished with input and is ready to edit either by automatically detecting that input has ended (e.g., by a timeout or a sentinel value) or by receiving user input such as by one or more of buttons 331 and 332.

FIG. 4 is an exemplary display depicting an illustrative embodiment of the invention responsive to editing English text. In this exemplary display, the section of screen labeled 410 continues to display the results of a speech recognition operation upon the spoken English input. However, there is now a cursor visible in 410, thus indicating the user is editing the text at this time.

Section 420 displays a virtual keyboard configured for input in the English language. For example, the keyboard displays keys corresponding to the English alphabet and in an order that corresponds to the order of letters in the English alphabet. It should be noted that other arrangements of keys may be utilized with the present invention, e.g., QWERTY or AZERTY. The system may determine that the user has finished with editing and is ready to resume input by, for example, automatically that editing has ended (e.g., by a timeout or a sentinel value) or by receiving user input, such as by one or more of buttons 431 and 432.

FIG. 5 is an exemplary display depicting an illustrative embodiment of the invention responsive to spoken Arabic input. The system may determine the user input by, for example, automatically detecting the language of input or by receiving user input, such as by one or more of buttons 531 and 532. In display 500, the section of screen labeled 510 now displays the results of a speech recognition operation upon the spoken Arabic input. There is no cursor visible in 510, thus indicating the user is not editing the text at this time. Here, the section of screen labeled 520 displays alternative recognized text. It should be noted that is merely an exemplary display and that other arrangements of components, e.g., modifications to their sizes or positions, will be apparent to one skilled in the art. Because the virtual keyboard is not displayed, space 520 may be used for other purposes.

For example, display 500 does not include a virtual keyboard; however, in an embodiment where the input includes text rather than speech, a virtual keyboard may be present and used during the input stage. The system may determine that the user has finished with input and is ready to edit either by automatically detecting that input has ended (e.g., by a timeout or a sentinel value) or by receiving user input, such as by one or more of buttons 531 and 532.

FIG. 6 is an exemplary display depicting an illustrative embodiment of the invention configured for editing Arabic text. In this exemplary display, the section of screen labeled 610 continues to display the results of a speech recognition operation upon the spoken Arabic input. However, there is now a cursor visible in 610, thus indicating the user is editing the text at this time.

Section 620 displays a virtual keyboard configured for input in the Arabic language. For example, the keyboard displays keys corresponding to the Arabic alphabet and in an order that corresponds to the order of letters in the Arabic alphabet. It should be noted that other arrangements of keys may be utilized with the present invention. The system may determine that the user has finished with editing and is ready for further input and/or generation of output by, for example, detecting that editing has ended (e.g., by a timeout or a sentinel value) or by receiving user input, such as by one or more of buttons 631 and 632.

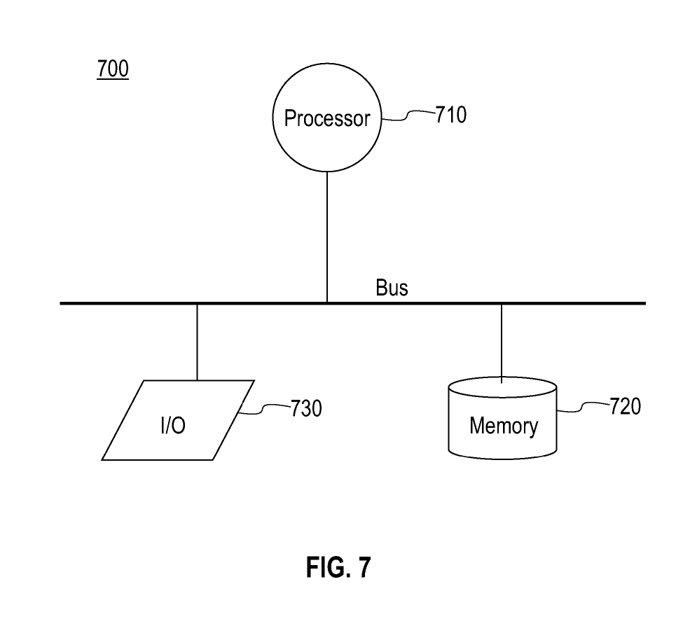

The methodologies of the invention may be particularly well-suited for use in an electronic device or alternative system. For example, FIG. 7 is a block diagram depicting an exemplary processing system 700. System 700 may include processor 710, memory 720 coupled to the processor (e.g., via bus 730 or an alternative connection), as well as input/output (I/O) circuitry 740 operative to interface with the processor. Processor 710 may be configured to perform at least a portion of the methodologies of the present invention, illustrative embodiments of which are shown in the above figures and described therein.

It is to be appreciated that the term “processor” as used herein is intended to include any processing device, such as, for example, one that includes a central processing unit (CPU) and/or other processing circuitry (e.g., digital signal processor (DSP), microprocessor, etc.). Additionally, it is to be understood that the term “processor” may refer to more than one processing device, and that various elements associated with a processing device may be shared by other processing devices. The term “memory” as used herein is intended to include memory and other computer-readable media associated with a processor or CPU, such as, for example, random access memory (RAM), read only memory (ROM), fixed storage media (e.g., a hard drive), removable storage media (e.g., a diskette), flash memory, etc. Furthermore, the term “I/O circuitry” as used herein is intended to include, for example, one or more input devices (e.g., keyboard, mouse, etc.) for entering data to the processor, and/or one or more output devices (e.g., printer, monitor, etc.) for presenting the results associated with the processor.

Accordingly, an application program, or software components thereof, including instructions or code for performing the methodologies of the invention, as described herein, may be stored in one or more of the associated storage media (e.g., ROM, fixed or removable storage) and, when ready to be utilized, loaded in whole or in part (e.g., into RAM) and executed by processor 710. In any case, it is to be appreciated that at least a portion of the components shown in the above figures may be implemented in various forms of hardware, software, or combinations thereof, e.g., one or more DSPs with associated memory, application-specific integrated circuit(s), functional circuitry, one or more operatively programmed general purpose digital computers with associated memory, etc. Given the teachings of the invention provided herein, one of ordinary skill in the art will be able to contemplate other implementations of the components of the invention.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method of adapting a virtual keyboard for multilingual input, the method comprising:
identifying an input language; and
displaying a virtual keyboard corresponding to the input language upon identification of the input language.

2. The method of claim 1, wherein the identifying step comprises:
manual selection of an input language; and
activation of at least one linguistic transformation module corresponding to the input language upon selection of the input language.

3. The method of claim 1, wherein the identifying step comprises automatic identification of an input language.

4. The method of claim 1, wherein the identifying step comprises the steps of:
operating at least one language identification module, each module being operative to identify whether the input is in at least one language; and
determining an input language which has been identified by one or more language identification modules.

5. The method of claim 1, wherein the identifying step comprises the steps of:
operating at least one language identification module, each module being operative to determine a probability that the input is in at least one language; and
identifying an input language which has been determined to have the highest probability.

6. The method of claim 5, wherein the identifying step further comprises:
identifying the input language only if the highest probability is greater than a threshold value.

7. The method of claim 5, wherein the identifying step further comprises:
Identifying the input language only if the highest probability exceeds at least another probability by a certain amount.

8. The method of claim 1, wherein the displaying step comprises displaying a preset keyboard layout in a designated display area.

9. The method of claim 1, wherein the displaying step comprises altering a keyboard layout in a designated display area.

10. The method of claim 9, wherein the altering step comprises at least one of altering a text input method, altering at least one key label, or altering a layout of keys.

11. A method of adapting a virtual keyboard for multilingual input, the method comprising:
determining an input language;
obtaining an input;
determining an end of the input; and
displaying a virtual keyboard corresponding to the input language upon the end of the input for use in an edit of input.

12. The method of claim 11, wherein the displaying step comprises the steps of:
determining an end of the edit; and
removing the virtual keyboard upon the end of the edit.

13. The method of claim 11, wherein at least one of the determining steps comprises detecting a sentinel value in a user input.

14. The method of claim 13, wherein the sentinel value comprises a cessation of input.

15. The method of claim 13, wherein the sentinel value comprises activation of a user control.

16. A system for adapting a virtual keyboard for multilingual input, the system comprising:
a memory; and
at least one processor coupled to the memory and operative to:
display a virtual keyboard corresponding to the input language upon identification of an input language.

17. The system of claim 16, wherein the processor is further operative to:
receive a manual selection of an input language; and
activate of at least one linguistic transformation module corresponding to the input language upon selection of the input language.

18. The system of claim 16, wherein the processor is further operative to identify an input language using automatic language identification.

19. The system of claim 16, wherein the processor is further operative to:
operate at least one language identification module, each module being operative to identify whether the input is in at least one language;
determine an input language which has been identified by one or more language identification modules.

20. An article of manufacture for adapting a virtual keyboard for multilingual input, the article comprising a machine readable medium containing one or more programs which when executed implement the steps of:
identifying an input language; and
displaying a virtual keyboard corresponding to the input language upon identification of the input language.
